(19) United States
(12) Patent Application Publication
(10) Pub. No.: US 2024/0062445 A1
(43) Pub. Date: Feb. 22, 2024

(54) IMAGE BASED AVATAR CUSTOMIZATION

(71) Applicant: Sony Interactive Entertainment Inc., Tokyo (JP)

(72) Inventor: Ryan Sutton, Venice, CA (US)

(21) Appl. No.: 17/890,593

(22) Filed: Aug. 18, 2022

(51) Int. Cl. G06T 13/40; G06T 17/10; G06V 40/16; G06V 40/10

(52) U.S. Cl. CPC G06T 13/40; G06T 17/10; G06V 40/168; G06V 40/103

(57) ABSTRACT

Image-based customization comprises extracting feature parameters of a subject in a digital image with one or more neural networks trained with a machine learning algorithm configured to determine feature parameters of the subject. The feature parameters are then applied to a virtual model of the subject.

### FIELD OF THE DISCLOSURE

Aspects of the present disclosure relate to importation of real-world objects into a virtual application. More specifically, aspects of the present disclosure are related to scanning and importation of real-world objects and human body features into an application for avatar customization.

### BACKGROUND OF THE DISCLOSURE

Video games and other applications sometimes include detailed characters that represent the user often referred to as avatars. Often users choose to make their avatar match the user's real world physical features. This may provide the user with a more satisfying experience as they may feel as if they are part of the universe of the videogame or application.

Importing objects into virtual environments in the past has been performed with elaborate 3-dimensional scanning equipment that employ lasers or other surface scanning methods such as structured light or conoscopic holography to create a map of the surface of the subject. Other methods such as photogrammetry use photographs of multiple angles or wide-angle photos to generate multiple views of a subject. From the photos points can be established to generate a 3-dimensional mesh of the subject. All of these methods require specialized equipment or expensive high-quality cameras and as such are inaccessible for the ordinary person desiring to create a three-dimensional model of themselves or an object, in their home.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a pictorial diagram depicting a method of image-based customization of an avatar using facial images according to an aspect of the present disclosure.

FIG. 2 is a flow diagram depicting a method of image-based customization of an avatar using facial images according to an aspect of the present disclosure.

FIG. 3 is a pictorial diagram depicting a method of image-based customization of an avatar using body images according to an aspect of the present disclosure.

FIG. 4 is a flow diagram depicting a method of image-based customization of an avatar using body images according to an aspect of the present disclosure.

FIG. 5 is a pictorial diagram of a method for image-based customization of a virtual object using object images according to an aspect of the present disclosure.

FIG. 6 is a flow diagram showing a method for image-based customization of a virtual object using object images according to an aspect of the present disclosure.

FIG. 7 is a pictorial diagram of another method for image-based customization of a virtual object using object images according to an aspect of the present disclosure.

FIG. 8 is a flow diagram showing another method for image-based customization of a virtual object using object images according to an aspect of the present disclosure.

FIG. 9A is a diagram depicting the basic form of an RNN having a layer of nodes each of which is characterized by an activation function, one input weight, a recurrent hidden node transition weight, and an output transition weight according to aspects of the present disclosure.

FIG. 9B, is a simplified diagram showing that the RNN may be considered a series of nodes having the same activation function moving through time according to aspects of the present disclosure.

FIG. 9C depicts an example layout of a convolutional neural network such as a CRNN according to aspects of the present disclosure.

FIG. 9D shows a flow diagram depicting a method for supervised training of a machine learning neural network according to aspects of the present disclosure.

FIG. 10 is a block system diagram for a system for image-based customization of a virtual model according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

According to aspects of the present disclosure subjects of digital images may be imported into virtual spaces through the use of one or more neural networks trained with a machine learning algorithm and configured to determine feature parameters of a subject within the image. Here, the subject may be a person's body, a person's face, an animal, any type of inanimate object, building, a plant or similar. A scene within an image may contain multiple subjects set on a background.

As used herein, a digital image refers to a visual representation of data. Such data may be obtained by transducing light from a source into electrical impulses with a sensor, converting the electrical impulses into digital data and storing or transmitting the digital data. Digital image data may be obtained with suitable imaging systems such as digital cameras, video cameras, light detection and ranging (LIDAR) systems, and the like.

Alternatively, digital image data may be generated synthetically. For example, a scene may be represented by digital data representing sets of vertices corresponding to objects within the scene. Each vertex may have associated parameter values, such as position values (e.g., X-Y coordinate and Z-depth values), color values, lighting values, texture coordinates, and the like. Vertex shading computations are performed, such as tessellation and geometry shader computations which may be optionally used to generate new vertices and new geometries in virtual space. Tessellation computations subdivide scene geometries and geometry shading computations to generate new scene geometries beyond those initially set up in an application. The scene geometry represented by the vertices is then converted into screen space and a set of discrete picture elements, i.e., pixels in a process known as rasterization. In this process, the virtual space geometry (which can be three-dimensional) is transformed to screen space geometry (which is typically two-dimensional) through operations that group subsets of the vertices to define sets of primitives in screen space and project vertices from virtual space to a viewing window (or “viewport) of the scene in screen space. The pixel data for the resulting image may then be transmitted or stored.

In some implementations, the digital image may be generated synthetically from two or more images that contain the same subject. Such images may be obtained from different angles. Three-dimensional data may be generated from analysis of the two images and the synthetic digital image could be generated from the three-dimensional data, e.g., as described above. In some implementations, if a particular subject can be recognized, a synthetic image of the subject may be stitched together from different angle views of scene containing the subject. Image analysis software may be used to recognize the particular subject and isolate it from other parts of the image. Furthermore, in some implementations, a synthetic image may be obtained by post-capture modification of a digital image. Such modification may involve manipulation of three-dimensional data representing an image containing a subject to distort or vary the proportions of the subject. For example a user interface could be configured to allow a user to manually stretch, pull, push, or curve the image or portions of the image. The resulting image could then be transmitted or stored.

As used herein, the subject of an image generally refers to a person or thing depicted in the image that is distinct from the background of the image. In accordance with aspects of the present disclosure, a user may, for example, use an image of the user's face to easily create an avatar having the user's likeness as a starting point for customization. In a like manner, a user may create customized avatars for virtual characters, virtual objects, even virtual animals or plants using images having a corresponding object, person, animal, or plant, as a subject.

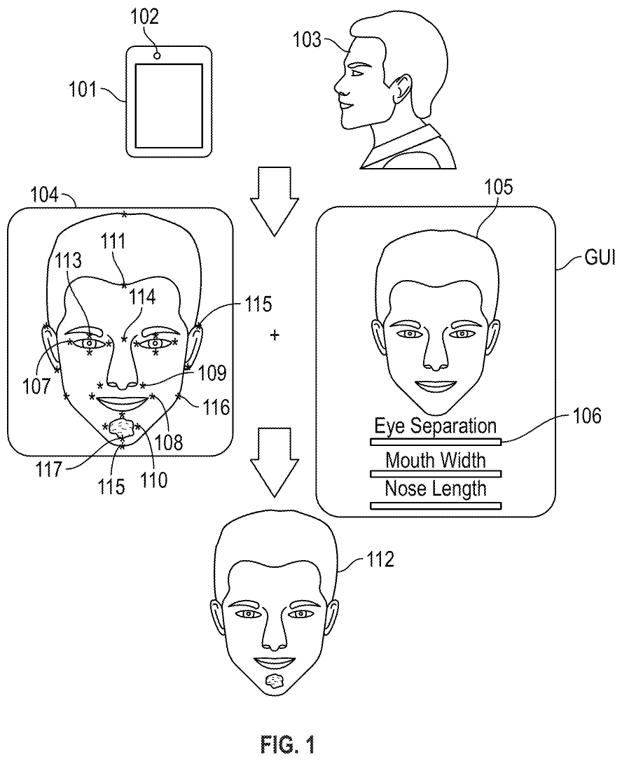

FIG. 1 is a pictorial diagram depicting an example of a method of image-based customization of an avatar using facial images according to an aspect of the present disclosure. Here a user 103 takes an image 104 of their face. In the implementation shown the image 102 is taken with a camera 102 integrated into a mobile device 101. The image may be a single photograph, a frame from a video or a synthetic image. In some implementations, the camera 102 may store the image 104 in digital form. Alternatively, the camera may produce a non-digital image that may be converted to digital form, e.g., with a scanner (not shown). Digital data corresponding to the image 104 is then analyzed by a neural network trained with a machine learning algorithm and configured to determine feature parameters within the image. Here, the feature parameters characterize facial landmarks and may include, but are not limited to Eye width 107, eye shape, eye separation, eye color, eye size 113, nose width 109, nose length 114, mouth shape, mouth location, mouth width 108, beard shape, beard location, beard width 110, beard length 117, hair shape, hair size, hair color, hair texture, hairline location 110, head shape, head length 115, head width, jaw shape 116, or any combination thereof or similar. In some implementations, the avatar customization system may present the user with a palette of other customization options, including accessories such as earrings, necklaces, rings, piercings, tattoos, hats, sunglasses, in addition to clothing styles or colors, and the like.

A blank virtual model 105 of a face may be selected from a database, generated or pre-generated. If for example and without limitation, the blank virtual model is selected from a database, one or more of the feature parameters such as head shape, head length 115, head width, and jaw shape 116 may be set to initial values. The blank virtual model 105 may have other feature parameter values that are genericized. For example and without limitation, the values of feature parameters that characterize facial landmarks of the blank model may be the average values for of the adult population or generated from the golden ratio. The feature parameters determined from the image 104 may then be applied to the blank virtual model 105 to create a customizable virtual model. To facilitate further customization, the avatar customization system may provide a user interface UI with sliders 106 that allow the user to adjust the feature parameter values for the customized virtual model to the preferences of the user. The starting points for one or more of the sliders may correspond to the feature parameter values determined from the image. This would allow the user to more easily customize the virtual model to their own taste. Once the feature parameters have been applied to model and (optionally) the user has modified the customized virtual model, the virtual model may be finalized to have the feature parameters determined from the image 104 and/or modified by the user 106 to generate a finalized model 112. The finalization process may apply the virtual model to an avatar in an application or generate an image with the three-dimensional finalized model as its subject.

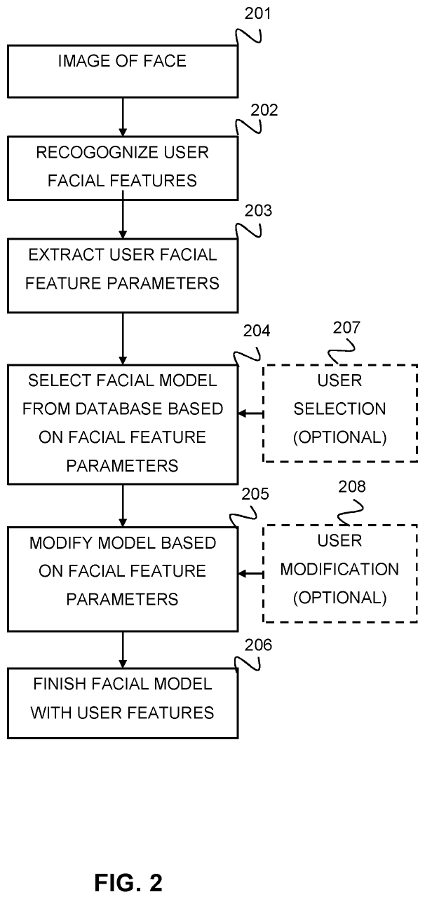

FIG. 2 is a flow diagram depicting a method of image-based customization of an avatar using facial images according to an aspect of the present disclosure. As shown, initially an image of a face is provided to the system as indicated at 202. The image may be digitized and facial features may be recognized at 202 from digital data corresponding to the image, for example and without limitation the existence of a face shape, head size, eye color, hair color or hair style may be detected. From the recognition of facial features, feature parameter values are extracted at 203. As discussed above the feature parameters may include facial landmarks such as eye width, eye shape, eye separation, eye size eye color, nose width, nose length, mouth shape, mouth location, mouth width, beard shape, beard location, beard width, beard length, hair shape, hair size, hair line location, hair color, hair texture, head shape, head length, head width, jaw shape, skin tone, or any combination thereof or similar.

In this implementation, the system has access to a database of pre-generated facial models. The models may have a variety of different pre-set facial features. The pre-set facial features may be facial features that are difficult to simply modify without changing the underlying structure of the model. For example, and without limitation, the pre-set facial features of the model may include face shape, jaw shape, head size, head width, head length, head shape or any combination thereof. A pre-generated facial model may be selected from the database based on some subset of the feature parameters and/or feature parameter values, as indicated at 204. In some optional implementations the user may be prompted to confirm the selection of a pre-generated facial model or select a different model that matches their preference 207. This may allow users to roughly modify their avatar's facial appearance before fine tuning other facial features in later steps. It should be understood that in some alternative implementations only a single facial model is available and as such that model will be chosen as the base facial model. In yet other implementations a base facial model may be generated using at least one feature parameter and/or feature parameter value determined from the image data.

Once the facial model has been selected or generated, the model is modified based on the facial feature parameters and/or facial feature parameter values, as indicated at 205. Each facial feature of the facial model may have a pre-set feature parameter associated with it. The facial feature parameters and/or facial feature parameter values taken from the image of the face may be applied to the pre-set feature parameters to modify the appearance of the facial model. Additionally certain modifications to the facial model may be made by adding features to the model based on certain feature parameters determined from the image. By way of example and without limitation, added features may include a beard, a moustache, a hair style, one or more tattoos, one or more piercings, one or more accessories (e.g., eyeglasses or sunglasses) one or more scars, one or more blemishes, one or more eyebrows, or any combination thereof. The feature parameters and/or feature parameter values may be used determine the location, size, shape, style, or any combination thereof, of the added features. In some optional implementations the user may be provided the opportunity to change the feature parameters and/or feature parameter values of the modified facial model, as indicated at 208. Sliders for each of the facial feature parameters may be provided to the user, e.g., via a graphical user interface GUI, with the values of the feature parameters determined from the image of the user as the starting point. The graphical user interface may also present an image corresponding to the facial model, which may change in accordance with the user's changes to the values of the facial feature parameters using the sliders. This may make it easier for the user to understand the starting point for customization of their avatar's facial model and provide an easy anchor point for facial customization.

After the facial model has been modified, the model may be finished or finalized, as indicated at 206. Finalizing the facial model may include for example and without limitation applying the modified facial model to a body model or avatar, generating image frames containing the modified facial model in a scene or similar.

It should be understood that, each feature parameter may have one or more corresponding feature parameter values associated with it to characterize the described feature. For example, if the subject in the image has blond hair, possible feature parameters for the subject's hair include hair color, among other things. The corresponding feature parameter value in this case would be “blond”. By contrast, if the subject has no hair there would be no feature parameter corresponding to hair color. Further as, discussed above, the system may incorporate a particular feature into the model based on the existence of a corresponding particular feature parameter, as determined from the image analysis. Additionally the determination of a feature parameter may also include determining the one or more of the corresponding feature parameter values associated with the determined feature parameter. In some implementations certain feature parameters may be necessary for the model. In such cases the feature parameter values may be determined as the existence of the parameter itself is pre-determined.

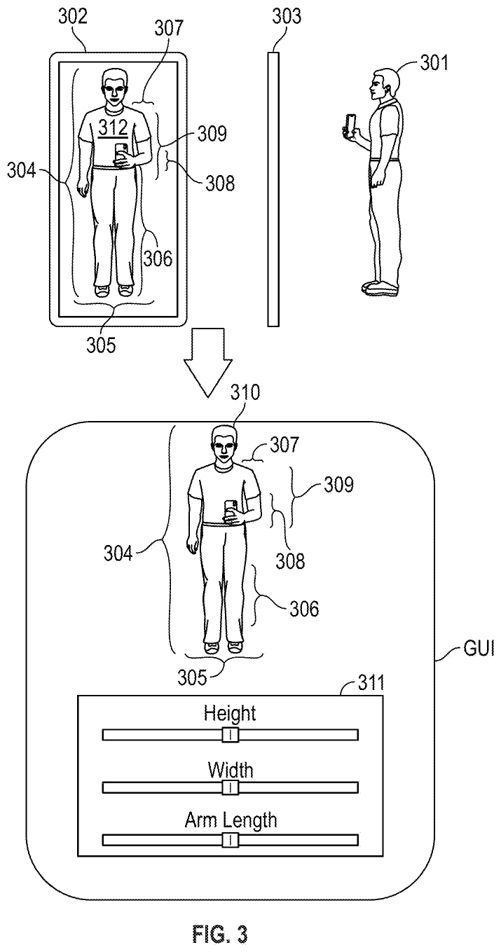

FIG. 3 is a pictorial diagram depicting a method of image-based customization of an avatar using body images according to an aspect of the present disclosure. In this implementation a user may take an image of their body 301. As shown, the user is creating an image of their body using an imaging device 302 and a mirror 303. In some implementations an image of a body may simply be provided to the system. From the image of the body 312 feature parameters and/or feature parameter values are identified. Here, the image of the body is taken using a mirror and the imaging device is included in the image. In some implementations the size of the imaging device may be used as an anchor in determining proportions or feature parameters values in the image. Alternatively, another anchor in the image may be chosen for this purpose. For example, the user may be prompted to hold up a credit card or piece of letter paper or other object that has a known size. The imaging device may be for example and without limitation, a cellphone, a camera, a tablet PC with camera, a web camera, digital scanner, or similar. The imaging device may provide the image in digital form or the avatar customization system may include a suitably configured digital scanner for this purpose. The feature parameters and/or feature parameter values may be identified from the digital image data by one or more neural networks trained with a machine learning algorithm and configured to determine body feature parameters and/or body feature parameter values from an image of a body. Additionally, the image of the body may be analyzed by one or more neural networks trained with a machine learning algorithm and configured to detect one or more bodies occurring within an image. In some implementations one or more additional neural networks may be used to determine facial feature parameters and/or facial feature parameter values, e.g., as discussed above with respect to FIG. 1 and FIG. 2.

Here, the feature parameters are body feature parameters and may include, by way of example and not by way of limitation, height 304, shoulder width 305, leg length 306, arm length 309, arm width 307, hand width 308 or the like. Additionally, as discussed above, facial feature parameters may be extracted from the image of the body, if an image of a face is unavailable.

After body feature parameters and/or body feature parameter values have been extracted, the body feature parameters and/or body feature parameter values may be applied to a body model 310 to generate a modified body model. The user may be provided with a graphical user interface GUI having sliders or knobs 311 which are configured to change the feature parameters values of the modified model. The graphical user interface may also present an image corresponding to the body model, which may change in accordance with the user's changes to the values of the body feature parameters using the sliders or knobs 311. This allows the user to further customize the look of the body after it has been modified. Additionally, in some implementations there may be a database of multiple unmodified body models and the body feature parameters values may be used to select the body model that best fits the parameters. For example and without limitation, there may be a database with multiple unmodified models having different body types, such as mesomorph, ectomorph, and endomorph body models, the body feature parameters may initially be analyzed to determine the body type from the parameters values and then the feature parameter values may be applied to the body model having a body type matching the body type identified from the feature parameters values. Additionally certain modifications to the body model may be made by adding features to the model based on certain feature parameters determined from the image. By way of example and without limitation, added features may include a body hair, one or more tattoos, one or more scars, one or more freckles, one or more birthmarks, or any combination thereof.

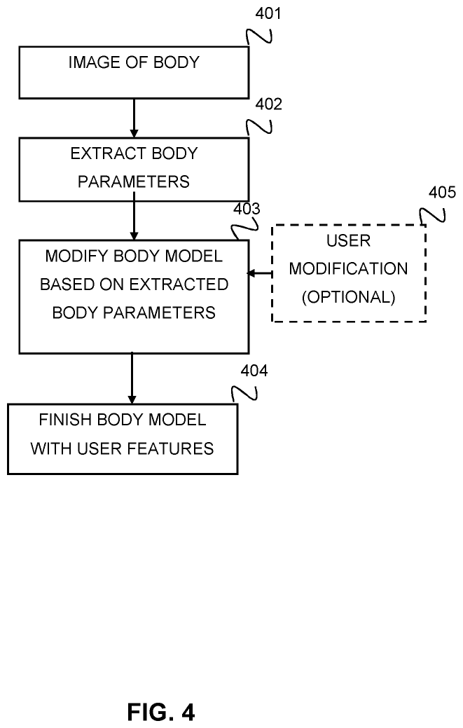

FIG. 4 is a flow diagram depicting a method of image-based customization of an avatar using body images according to an aspect of the present disclosure. First the image-based customization system is provided an image 401 of a person's body. The image may be an image of the user's body, or another person's body. The image 401 may be for example and without limitation an image of a person taken using a mirror, or an image taken of a person by another person, or an image of a person taken using a camera timer. The image 401 may be obtained in digital form, e.g., with a digital camera, or may be converted to such digital form, e.g., using a digital scanner.

Feature parameters and/or feature parameter values are extracted at 402 from digital image data corresponding to the image 401 using one or more a neural networks trained with a machine learning algorithm and configured to determine feature parameters and/or feature parameter values from an image of a body. In some implementations, facial feature parameters and/or facial feature parameter values may be extracted using one or more neural networks trained with a machine learning algorithm configured to determine facial feature parameters and/or facial feature parameter values as discussed above. Additionally, object feature parameters and/or object feature parameter values may be extracted from one or more objects in the image of the body using a neural network trained with a machine learning algorithm and configured to determine object feature parameters and/or object feature parameter values from the image. In some implementations the image of a body may be provided to one or more recognition neural networks trained with a machine learning algorithm to identify bodies, faces and/or objects that may be within an image before being provided to the one or more body feature parameter determination neural networks. The identification neural networks may determine the existence and location of bodies, faces and/or objects occurring within the image, this may be used to determine what portions of the image are provided to the body feature parameter determination networks, facial feature determination networks and/or object feature determination networks.

In the implementation shown, a body model is modified using the body feature parameters and/or body feature parameter values at 403 to generate a modified virtual body model for an avatar. Elements of the body model may be tied to feature parameters and when the feature parameter values are adjusted the corresponding elements of the body model are adjusted. For example and without limitation, a body feature parameter such as arm length may be tied to the length of a depicted arm element of the model. In some implementations body feature parameters may be tied to elements of the model that are not related to the body feature parameter. For example, a monster avatar could be created based on the body in the image by applying the body feature parameters to unrelated elements of the model such as arm length applied to leg elements of the model or chest length applied as neck length, etc. In some other alternative implementations, a completely different model for example and without limitation the model of a dog or cat may have body feature parameters applied to elements such as arm length applied to foreleg length and leg length applied to hind leg length etc. In yet other implementations a database of pre-generated virtual body models may be used with the body feature parameters. For example and without limitation, the body feature parameters may be used to choose a pre-generated virtual body model from the database, in some implementations proportions taken from the body features may be used to determine a body type which may be used to select a virtual body model from the database.

The user may (optionally) further customize elements of the model 405 after the model has been modified using the body feature parameters. The user may be provided with a graphical user interface with sliders for each of the body feature parameters associated with elements of the body model. The body feature parameter values of the modified virtual body model may be used as the starting values for the sliders. The graphical user interface may also present an image corresponding to the virtual body model, which may change in accordance with the user's changes to the values of the body feature parameters using the sliders.

After the virtual body model has been modified it is finalized as shown at 404. Finalizing the virtual body model may include for example and without limitation applying a modified facial model to the virtual body model or avatar, generating image frames containing the modified virtual body model in a scene or similar.

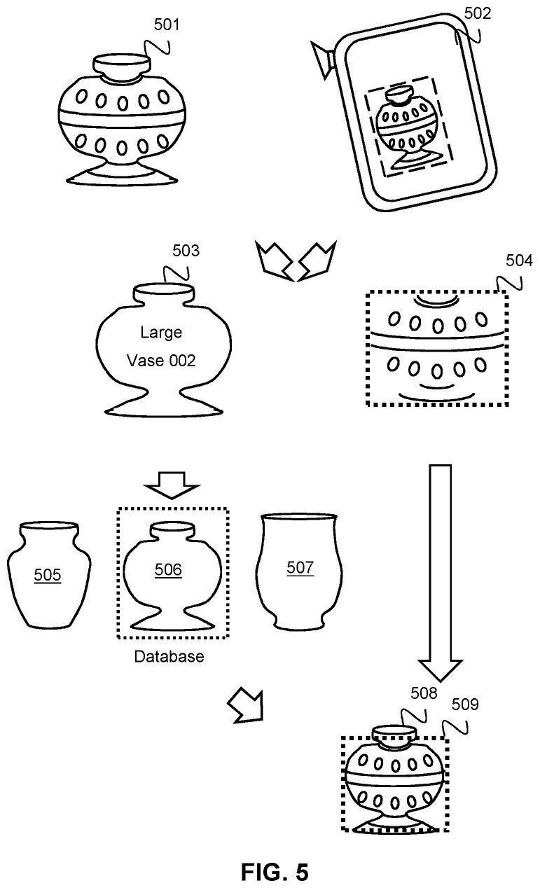

FIG. 5 is a pictorial diagram of a method for image-based customization of a virtual object using object images according to an aspect of the present disclosure. As shown an image 501 of an object 502 may be provided to a system for image-based customization of virtual objects. Here the object 502 is a vase and the image is generated by an image capture device such as a cellphone or tablet computer having a camera. The image 501 may be obtained in digital form or converted to digital form to facilitate image analysis. One or more object recognition neural networks trained by a machine learning algorithm to recognize objects occurring within images may be applied to the image (or to digital data corresponding to the image) to determine identity of the object 503 within the image. One or more object recognition neural networks may be trained from a database of labeled objects and the one or more object neural networks generate a label for the object corresponding to one or more objects within the object database. In the implementation shown the database includes three vase models 505, 506, 507. The one or more object recognition neural networks may determine that the object in the image 503 corresponds to a label, large vase 002, and as such the model 506 in the database corresponding to large vase 002, is chosen. In some implementation one or more additional object parameter determination neural networks trained with a machine learning algorithm and configured to determine object feature parameters and/or object feature parameter values from the image may be used with the image to generate object feature parameters and/or object feature parameter values. The object feature parameters may include an object width, object height, object length and/or similar. In some implementations the object feature parameters may be specialized for the object recognized within the image. By way of example and not by way of limitation the trained neural networks configured to determine one or more object feature parameters and/or object feature parameter values may be trained to recognize object feature parameters and/or object feature parameter values for each object within the database. The model additionally, may be modified using the object feature parameters to generate a modified model. Optionally the user may customize the object feature parameters of the modified model. The user may be provided with a graphical user interface having sliders or similar controls that allow the customization of the object feature parameter values and the identified object feature parameter values may be used as the starting settings. This may allow the user to have an easy starting point for customizing the look of the object. The graphical user interface may also present an image corresponding to the selected object model 506, which may change in accordance with the user's changes to the values of the object feature parameters using the sliders.

Additionally, one or more textures, surface designs and/or images may be captured from the surface of the object as shown at 504 to generate a model surface applique. In some implementations an output from the one or more object recognition neural networks may be used to determine the location of the object. The portion of the image containing the object may then be copied and used as the model surface applique. Additionally in some implementations the model surface applique may be modified to improve its appearance for example, large black areas corresponding to shadows in the image may be removed.

Finally, the model surface applique may be applied 509 to the model 508 and the model may be finalized. To apply the applique to the model, the applique may be distorted to wrap the applique around the model surface.

The applique may be applied to the model using, e.g., convention three dimensional (3D) computer graphics. Specifically, the three dimensional model may be converted to one or more two-dimensional (2D) images in a vector format using reprojection techniques. A computer graphics system may then use rasterization to convert the two-dimensional image vector format may be converted into pixels for output on a video display or printer. Each pixel may be characterized by a location, e.g., in terms of vertical and horizontal coordinates, and a value corresponding to intensities of different colors that make up the pixel. Vector graphics represent an image through the use of geometric objects such as curves and polygons. Some simple 3D rendering engines transform object surfaces into triangle meshes, and then the triangles rasterised in order of depth in the 3D scene.

Scan-line algorithms are commonly used to rasterize polygons. A scan-line algorithm overlays a grid of evenly spaced horizontal lines over the polygon. On each line, where there are successive pairs of polygon intersections, a horizontal run of pixels is drawn to the output device. These runs collectively cover the entire area of the polygon with pixels on the output device. The applique may be in the form of a texture that the computer graphics can “paint” onto the polygons. In such a case each pixel value drawn by the output device is determined from one or more pixels sampled from the texture. As used herein, a bitmap generally refers to a data file or structure representing a generally rectangular grid of pixels, or points of color, on a computer monitor, paper, or other display device. The color of each pixel is individually defined. For example, a colored pixel may be defined by three bytes—one byte each for red, green and blue. A bitmap typically corresponds bit for bit to an image displayed on a screen, probably in the same format as it would be stored in the display's video memory or maybe as a device independent bitmap. A bitmap is characterized by the width and height of the image in pixels and the number of bits per pixel, which determines the number of colors it can represent.

The process of transferring a texture bitmap to a surface often involves the use of texture MIP maps (also known as mipmaps). Such mipmaps are pre-calculated, optimized collections of bitmap images that accompany a main texture, intended to increase rendering speed and reduce artifacts. They are widely used in 3D computer games, flight simulators and other 3D imaging systems. The technique is known as mipmapping. The letters “MIP” in the name are an acronym of the Latin phrase multum in parvo, meaning “much in a small space”.

Each bitmap image of the mipmap set is a version of the main texture, but at a certain reduced level of detail. Although the main texture would still be used when the view is sufficient to render it in full detail, the graphics device rendering the final image (often referred to as a renderer) will switch to a suitable mipmap image (or in fact, interpolate between the two nearest) when the texture is viewed from a distance, or at a small size. Rendering speed increases since the number of texture pixels (“texels”) being processed can be much lower than with simple textures. Artifacts may be reduced since the mipmap images are effectively already anti-aliased, taking some of the burden off the real-time renderer.

If the texture has a basic size of 256 by 256 pixels (textures are typically square and must have side lengths equal to a power of 2), then the associated mipmap set may contain a series of 8 images, each half the size of the previous one: 128×128 pixels, 64×64, 32×32, 16×16, 8×8, 4×4, 2×2, 1×1 (a single pixel). If, for example, a scene is rendering this texture in a space of 40×40 pixels, then an interpolation of the 64×64 and the 32×32 mipmaps would be used. The simplest way to generate these textures is by successive averaging, however more sophisticated algorithms (perhaps based on signal processing and Fourier transforms) can also be used. The increase in storage space required to store all of these mipmaps for a texture is a third, because the sum of the areas ¼+ 1/16+ 1/256+ . . . converges to ⅓. (This assumes compression is not being used.)

The blending between mipmap levels typically involves some form of texture filtering. As used herein, texture filtering refers to a method used to map texels (pixels of a texture) to points on a 3D object. A simple texture filtering algorithm may take a point on an object and look up the closest texel to that position. The resulting point then gets its color from that one texel. This simple technique is sometimes referred to as nearest neighbor filtering. More sophisticated techniques combine more than one texel per point. Commonly used algorithms include bilinear filtering and trilinear filtering using mipmaps. Anisotropic filtering and higher-degree methods, such as quadratic or cubic filtering, may be used for even higher quality images.

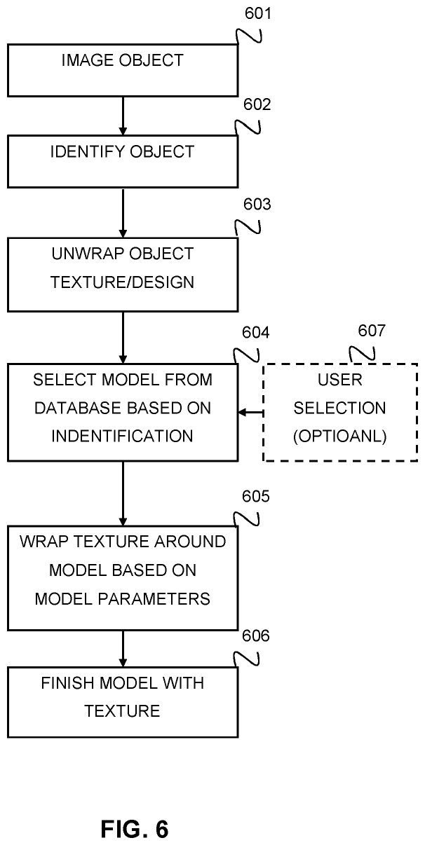

FIG. 6 is a flow diagram showing a method for image-based customization of a virtual object using object images according to an aspect of the present disclosure. In the implementation shown, an image includes an object as the subject of the image 601. The image is provided to a neural network trained with a machine learning algorithm configured to identify objects within the image. The neural network may identify one or more objects within the image 602. Additionally, object feature parameters and/or object feature parameter values may be determined from the image using one or more neural networks trained with a machine learning algorithm to determine object parameters and/or object feature parameter values.

One or more textures, designs or surface images may then be unwrapped from the object 603. To unwrap one or more textures, designs, or images from the surface of the object, a portion of the image containing the object may be extracted and the background or other objects within the portion of the image may be removed to generate a model surface applique, e.g., in the form of one or more textures. The identity of the object recognized at 602 may be used to further refine the model for example a model shape identified from the object may be used to more accurately select the one or more textures, designs or surface images on the surface of the object.

Based on the identity of the object a virtual model from a database of virtual models of objects may be selected 604. The one or more neural networks may be trained based on the database of virtual models and as such the identity of the object may correspond to the identity of one of the objects within the database. Thus, the virtual model in the database with the identity corresponding to the identity of the object may be selected. User input 607 may optionally be used to select a different model from the database. Alternatively, in some implementations, user input may optionally be used to customize the virtual model. The object feature parameters may for example and without limitations, first be used to modify the model and then the user may be provided the option to further customize the model based on the modified feature parameters. Sliders or knobs may be used to customize the object feature parameters, with the determined object feature parameters values as the initial value for the knob or sliders before user customization. The graphical user interface may also present an image corresponding to the virtual body model, which may change in accordance with the user's changes to the values of the object feature parameters using the sliders.

After a virtual model has been chosen and optionally customized, a model surface applique maybe applied to the surface of the virtual model 605, e.g., using textures as discussed above. The model surface applique may be modified based on for example, the object feature parameters, to fit the model.

Once the virtual object model has had the model surface applique digitally applied to the model surface, it is finalized as shown at 606. Finalizing the virtual object model may include for example and without limitation applying the virtual object model to a virtual body model or avatar, generating image frames containing the virtual object model in a scene or similar. For example and without limitation, a virtual object model maybe a vase as shown in FIG. 5 and the virtual object model may be placed in a scene with a body model holding the vase.

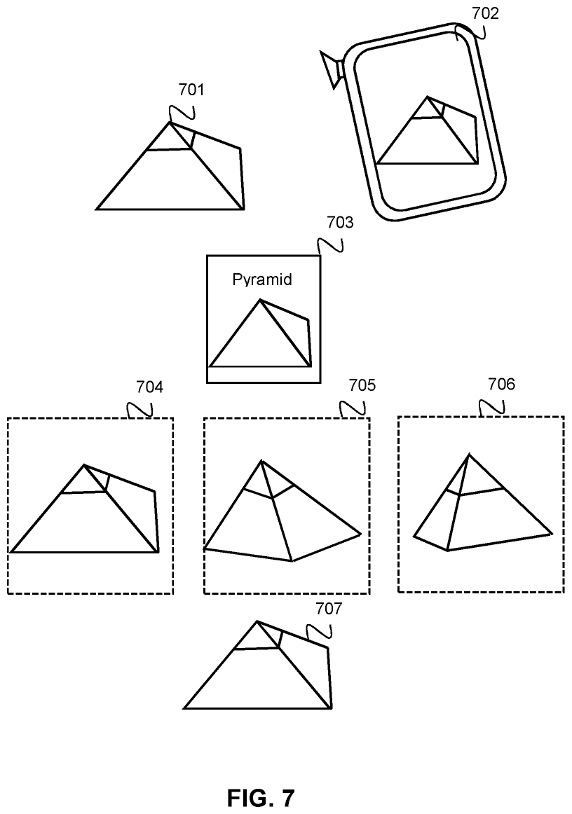

FIG. 7 is a pictorial diagram of another method for image-based customization of a virtual object using object images according to an aspect of the present disclosure. In the implementation shown, one or more images 702 are taken of an object 701. Here, the object 701 is a pyramid.

One or more neural networks trained with a machine learning algorithm and configured to identify primitive shapes of objects appearing within one or more images may be used to identify primitive shapes in the one or more images 703. Here the primitive shape has been identified as a pyramid. A single image or multiple images may be used with one or more neural networks to identify the primitive. Once the primitive shape has been identified it may be generated or chosen from a database of pre-generated primitives.

Additionally, a model surface applique may be generated using the multiple images of the object. Here images are taken from a first angle 704, a second angle 705 and a third angle 706 of the object are shown. The multiple angle images of the object may be used to assemble a complex model surface applique and determine object feature parameters. One or more neural networks trained with a machine learning algorithm to determine object feature parameters and/or object feature parameter values from multiple images may be used to generate feature parameters and/or object feature parameters that may be applied to the primitive shape.

Once a model surface applique and object feature parameters and/or object feature parameter values have been determined, they may be applied to the primitive to create a modified primitive 707 to generate a virtual object. Each primitive may include elements that are tied to different feature parameters. For example and without limitation, in the example of a pyramid, the element of base length, base width and height may each be elements of the virtual model tied to their respective feature parameters of object base length, object base width and object height. After the virtual object is generated it may be finalized. Finalizing the virtual object may include for example and without limitation applying the virtual object model to a virtual body model or avatar, generating image frames containing the virtual object model in a scene or similar. For example and without limitation, a virtual object may be a pyramid building and the virtual object may be placed in a scene with a body model next to the pyramid building.

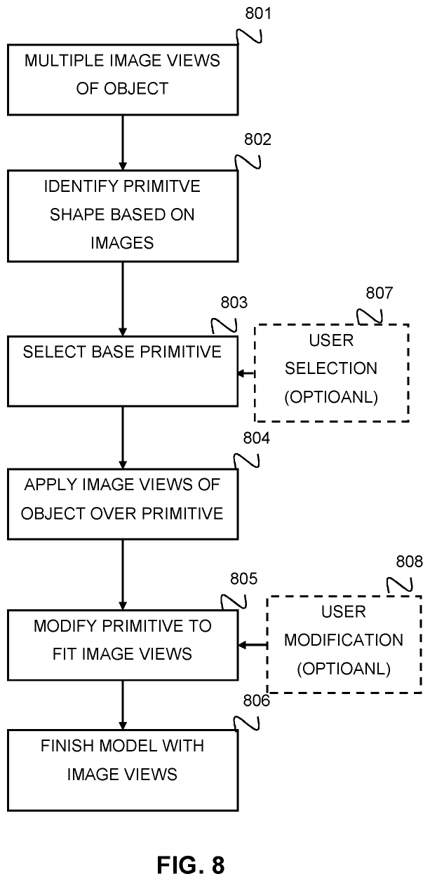

FIG. 8 is a flow diagram showing another method for image-based customization of a virtual object using object images according to an aspect of the present disclosure. Here, multiple images having at least one object as a subject are provided to the system 801. From one or more of the multiple images a primitive is identified 802 using one or more neural networks trained with a machine learning algorithm configured to identify primitive shapes of objects in one or more images. In some implementations, before a primitive shape of an object is identified, one or more neural networks trained with a machine learning algorithm to recognize objects occurring within an image may select portions of the image to provide to one or more primitive shape determination networks. Once a primitive shape has been identified it may be generated as a virtual model or selected from a database or pre-generated primitive models. 803 User input 807 may be used to refine the selected base primitive or choose a better primitive to fit the object within the image.

After a base primitive has been selected, a surface applique made from the multiple views of the object may be applied to the surface of the primitive 804. The surface applique may be created by selecting the portion of the image having the primitive and stitching together the images portions of the surface of the object.

Once the surface applique is applied to the primitive, the primitive may be modified to better fit the surface applique 805. For example and without limitation, the dimensions of the primitive may be changed so that the surface applique covers an entire surface of the primitive. The user may be provided with the ability to further customize the primitive to better fit the primitive to the object shape.

Finally, the primitive may be finalized with the surface applique and modified primitive shape at 806. Finalizing the modified primitive may include for example and without limitation, applying the modified primitive to a virtual body model or avatar, generating image frames containing the virtual object model in a scene or similar. For example and without limitation, a modified primitive maybe a pyramid as shown in FIG. 7 and the virtual primitive may be placed in a scene with a body model holding standing next to it.

General Neural Network Training

According to aspects of the present disclosure, the image-based customization system may use machine learning with neural networks (NN). For example, the recognition and parameter determination steps as discussed above may use machine learning as discussed below. The machine learning algorithm may use a training data set, which may include images with faces as a subject having labels for facial feature parameters such as facial landmarks, or face features such as eye color, hair color, beard color etc. The label for the facial feature parameter may include a label for the facial feature itself and in some implementations one or more labels for facial feature parameter values associated with the facial feature. In some implementations the training data set may include images with bodies as a subject and having labels for body feature parameters such as body measurements and other body features such as skin color, scar placement, or hair locations. The label for the body feature parameter may include a label for the body feature itself and in some implementations one or more labels for body feature parameter values associated with the body feature. In yet other implementations, the training data set may have images including one or more objects as a subject and having labelings for the object identity and/or object parameters such as length, width and height. The label for the object feature parameter may include a label for the object feature itself and in some implementations one or more labels for object feature parameter values associated with the object feature. In other implementations the training data may include objects and labelings for a shape primitive corresponding to the object's shape. In further implementations the training set may include any combination of images having labeled, bodies, faces, primitives and objects. During training, the labels of the training set may be masked.

The NNs may include one or more of several different types of neural networks and may have many different layers. By way of example and not by way of limitation the neural network may consist of one or multiple convolutional neural networks (CNN), recurrent neural networks (RNN) and/or dynamic neural networks (DNN). The Motion Decision Neural Network may be trained using the general training method disclosed herein.

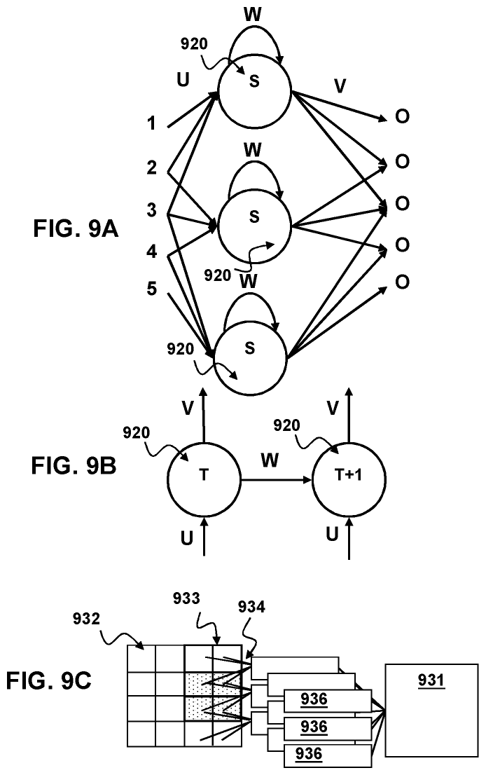

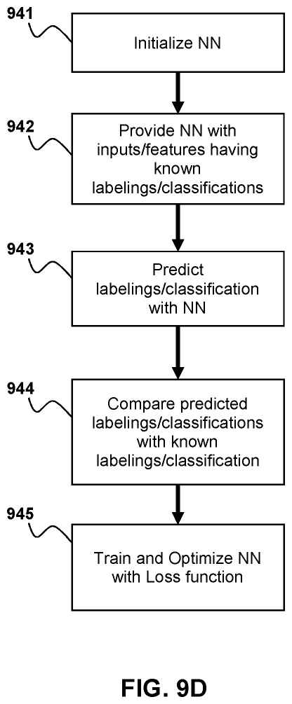

By of example, and not limitation, FIG. 9A depicts the basic form of an RNN that may be used, e.g., in the trained model 805. In the illustrated example, the RNN has a layer of nodes 920, each of which is characterized by an activation function S, one input weight U, a recurrent hidden node transition weight W, and an output transition weight V. The activation function S may be any non-linear function known in the art and is not limited to the (hyperbolic tangent (tan h) function. For example, the activation function S may be a Sigmoid or ReLu function. Unlike other types of neural networks, RNNs have one set of activation functions and weights for the entire layer. As shown in FIG. 9B, the RNN may be considered as a series of nodes 920 having the same activation function moving through time T and T+1. Thus, the RNN maintains historical information by feeding the result from a previous time T to a current time T+1.

In some implementations, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9(8):1735-1780 (1997), which is incorporated herein by reference.

FIG. 9C depicts an example layout of a convolution neural network such as a CRNN, which may be used, e.g., in the trained model 805 according to aspects of the present disclosure. In this depiction, the convolution neural network is generated for an input 932 with a size of 4 units in height and 4 units in width giving a total area of 16 units. The depicted convolutional neural network has a filter 933 size of 2 units in height and 2 units in width with a skip value of 1 and a channel 936 of size 9. For clarity in FIG. 9C only the connections 934 between the first column of channels and their filter windows is depicted. Aspects of the present disclosure, however, are not limited to such implementations. According to aspects of the present disclosure, the convolutional neural network may have any number of additional neural network node layers 931 and may include such layer types as additional convolutional layers, fully connected layers, pooling layers, max pooling layers, local contrast normalization layers, etc. of any size.

As seen in FIG. 9D Training a neural network (NN) begins with initialization of the weights of the NN at 941. In general, the initial weights should be distributed randomly. For example, an NN with a tan h activation function should have random values distributed between

$$\\ - \frac{1}{\sqrt{n}} and \frac{1}{\sqrt{n}}$$

where n is the number of inputs to the node.

After initialization, the activation function and optimizer are defined. The NN is then provided with a feature vector or input dataset at 942. Each of the different feature vectors may be generated by the NN from inputs that have known labels. Similarly, the NN may be provided with feature vectors that correspond to inputs having known labeling or classification. The NN then predicts a label or classification for the feature or input at 943. The predicted label or class is compared to the known label or class (also known as ground truth) and a loss function measures the total error between the predictions and ground truth over all the training samples at 944. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function and using known methods of training for neural networks such as backpropagation with adaptive gradient descent etc., as indicated at 945. In each training epoch, the optimizer tries to choose the model parameters (i.e., weights) that minimize the training loss function (i.e., total error). Data is partitioned into training, validation, and test samples.

During training, the Optimizer minimizes the loss function on the training samples. After each training epoch, the model is evaluated on the validation sample by computing the validation loss and accuracy. If there is no significant change, training can be stopped, and the resulting trained model may be used to predict the labels of the test data.

Thus, the neural network may be trained from inputs having known labels or classifications to identify and classify those inputs. Similarly, a NN may be trained using the described method to generate a feature vector from inputs having a known label or classification. While the above discussion is relation to RNNs and CRNNS the discussions may be applied to NNs that do not include Recurrent or hidden layers.

System

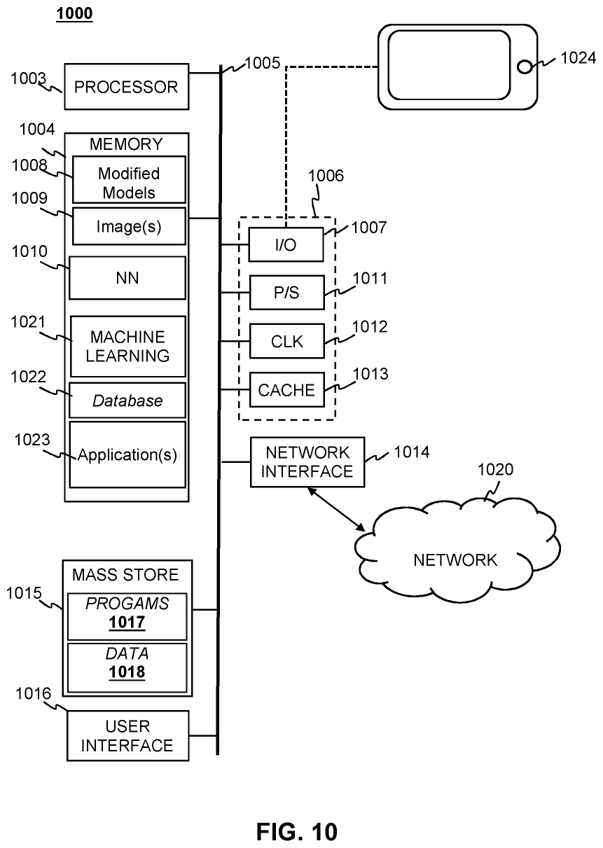

FIG. 10 is a block system diagram for a system for image-based customization of a virtual model according to aspects of the present disclosure. By way of example, and not by way of limitation, according to aspects of the present disclosure, the system 1000 may be an embedded system, mobile phone, personal computer, tablet computer, portable game device, workstation, game console, and the like.

The system 1000 generally includes a central processor unit (CPU) 1003, and a memory 1004. The system 1000 may also include well-known support functions 1006, which may communicate with other components of the system, e.g., via a data bus 1005. Such support functions may include, but are not limited to, input/output (I/O) elements 1007, power supplies (P/S) 1011, a clock (CLK) 1012 and cache 1013.

The system 1000 may include a display device to present rendered graphics to a user. In alternative implementations, the display device is a separate component that works in conjunction with the system, 1000. The display device may be in the form of a flat panel display, head mounted display (HMD), cathode ray tube (CRT) screen, projector, or other device that can display visible text, numerals, graphical symbols, or images. Additionally, the system 1000 may optionally include an image generator 1024. The image generator 1024 may generate one or more images 1009 that may be stored in the memory 1004. The image generator 1024 may be for example and without limitation, a camera, a video camera, a camera phone, a smartphone, a tablet personal computer having a camera, a web camera or similar.

The system 1000 includes a mass storage device 1015 such as a disk drive, CD-ROM drive, flash memory, solid state drive (SSD), tape drive, or the like to provide non-volatile storage for programs and/or data. The system 1000 may also optionally include a user interface unit 1016 to facilitate interaction between the system 1000 and a user. The user interface 1016 may include a keyboard, mouse, joystick, light pen, game pad or other device that may be used in conjunction with a graphical user interface (GUI). The system 1000 may also include a network interface 1014 to enable the device to communicate with other devices over a network 1020. The network 1020 may be, e.g., a local area network (LAN), a wide area network such as the internet, a personal area network, such as a Bluetooth network or other type of network. These components may be implemented in hardware, software, or firmware, or some combination of two or more of these.

The CPU 1003 may each include one or more processor cores, e.g., a single core, two cores, four cores, eight cores, or more. In some implementations, the CPU 1003 may include a GPU core or multiple cores of the same Accelerated Processing Unit (APU). The memory 1004 may be in the form of an integrated circuit that provides addressable memory, e.g., random access memory (RAM), dynamic random-access memory (DRAM), synchronous dynamic random-access memory (SDRAM), and the like. The main memory 1004 may include application data 1023 used by the processor 1003 while processing. The main memory 1004 may also include images 1009 received from an image generator 1024. A trained Neural Network (NN) 1010 may be loaded into Memory 1004 for determination of feature parameters and body, face, or object identification as discussed with regards to FIGS. 1-8. Additionally, the Memory 1004 may include machine learning algorithms 1021 for training or adjusting the NN 1010. A database 1022 may be included in the memory 1004. The database may contain virtual models of faces, bodies, objects, shape primitives and the like depending upon the desired implementation. The memory may also contain modified models 1008 generated from the database and feature parameters. The modified models may further be customized using inputs from the user received through the user interface 1016. The user interface 1016 may include sliders or knobs for further customizing the modified models 1008 before finalization and the feature parameter values may be the initial value for the sliders to provide a coherent reference starting point for model modification.

According to aspects of the present disclosure the processor 1003 may carry out methods for image-based model customization of a virtual model as discussed in FIGS. 2, 4, 6, and 8. These methods may be loaded into memory 1004 as applications 1023. The processor may generate modified models as a result of carrying out the methods described in FIGS. 2, 4, 6, and 8.

The Mass Storage 1015 may contain Application or Programs 1017 that are loaded in to the main memory 1004 when processing begins on the application 1023. Additionally, the mass storage 1015 may contain data 1018 used by the processor during processing of applications 1023, NN 1010, machine learning algorithms 1021 and filling the database 1022.

As used herein and as is generally understood by those skilled in the art, an application-specific integrated circuit (ASIC) is an integrated circuit customized for a particular use, rather than intended for general-purpose use.

As used herein and as is generally understood by those skilled in the art, a Field Programmable Gate Array (FPGA) is an integrated circuit designed to be configured by a customer or a designer after manufacturing—hence “field-programmable”. The FPGA configuration is generally specified using a hardware description language (HDL), similar to that used for an ASIC.

As used herein and as is generally understood by those skilled in the art, a system on a chip or system on chip (SoC or SOC) is an integrated circuit (IC) that integrates all components of a computer or other electronic system into a single chip. It may contain digital, analog, mixed-signal, and often radio-frequency functions—all on a single chip substrate. A typical application is in the area of embedded systems.

A typical SoC includes the following hardware components:
One or more processor cores (e.g., microcontroller, microprocessor, or digital signal processor (DSP) cores.
Memory blocks, e.g., read only memory (ROM), random access memory (RAM), electrically erasable programmable read-only memory (EEPROM) and flash memory.
Timing sources, such as oscillators or phase-locked loops.
Peripherals, such as counter-timers, real-time timers, or power-on reset generators.
External interfaces, e.g., industry standards such as universal serial bus (USB), FireWire, Ethernet, universal asynchronous receiver/transmitter (USART), serial peripheral interface (SPI) bus.
Analog interfaces including analog to digital converters (ADCs) and digital to analog converters (DACs).
Voltage regulators and power management circuits.

These components are connected by either a proprietary or industry-standard bus. Direct Memory Access (DMA) controllers route data directly between external interfaces and memory, bypassing the processor core and thereby increasing the data throughput of the SoC.

A typical SoC includes both the hardware components described above, and executable instructions (e.g., software or firmware) that controls the processor core(s), peripherals, and interfaces.

Aspects of the present disclosure allow for great flexibility and ease of use in customizing avatars and digital assets. Users can more easily customize avatars and digital assets generated from digital images compared to creating custom avatars from scratch using a generic template. Digital cameras are widely available and easy to use. They are a common feature of many smartphones, laptop computers and are often available as peripherals for gaming consoles. Furthermore, digital cameras and digital scanners can easily convert a conventional photograph or other image into a digital format. By leveraging digital image creation, aspects of the present disclosure provide a great deal of flexibility and opportunities for creativity in customizing avatars and digital assets.

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for image-based customization, comprising:
a) extracting one or more feature parameters of a subject in a digital image with one or more neural networks trained with a machine learning algorithm configured to determine feature parameters of the subject;
b) applying the one or more feature parameters to a virtual model of the subject.

2. The method of claim 1, wherein the digital image corresponds to a still image.

3. The method of claim 1, wherein the digital image corresponds to a frame of video.

4. The method of claim 1, wherein the digital image is a synthetic image generated from vertex data.

5. The method of claim 1, wherein the digital image is a synthetic image stitched together from two or more different images containing the subject.

6. The method of claim 1 wherein the subject of the image is the face of a user and the feature parameters of the subject include facial landmarks.

7. The method of claim 1 wherein the feature parameters further include eye color, hair color, or hair style.

8. The method of claim 1 wherein the model is a human face.

9. The method of claim 1 wherein the subject is a human body and extracting feature parameters further includes identifying a user's body and determining the user's body feature parameters.

10. The method of claim 9 wherein the body parameters include height, shoulder width, hip width, leg shape, arm length, leg length, arm shape, or chest width

11. The method of claim 9 wherein extracting feature parameters further comprises identifying the user's face and determining the user's facial feature parameters.

12. The method of claim 1 wherein applying the feature parameters to a model further comprises adjusting sliders for features of a model to match the feature parameters to generate an adjusted model.

13. The method of claim 12 wherein the adjusted model is a starting point for adjustment of features of the model by the user.

14. The method of claim 1 wherein applying the feature parameters to a model further includes selecting the model from a database of potential models based on at least one of the feature parameters.

15. The method of claim 1 further comprising identifying the subject in the image with a neural network trained with a machine learning algorithm and configured to identify objects occurring within images.

16. The method of claim 15 wherein identifying the subject in the image further comprises determining a primitive shape of the subject.

17. The method of claim 16 wherein the model is a primitive shape and applying the feature parameter to a model further comprises selecting the primitive shape of the model from a database of three-dimensional primitive shapes.

18. The method of claim 17 wherein applying the feature parameters to the model further comprises modifying the primitive shaped model according to at least one feature parameter to generate a modified primitive model.

19. The method of claim 18 wherein modifying the primitive shaped model further includes adjusting the modified primitive model with user adjustable feature parameters sliders.

20. The method of claim 1 wherein extracting feature parameters further includes generating one or more textures, images, or designs from a surface of the subject

21. The method of claim 20 wherein applying the feature parameters to the mode further includes applying the one or more textures, images or designs taken from the surface of the subject to the model.

22. The method of claim 21 wherein applying the one or more textures, images, or designs to the surface of the model further comprises using one or more user adjustable sliders to fit the one or more textures, images or designs on to the surface of the model.

23. A system for image based customization, comprising:
a processor;
a memory coupled to the processor;
Non-transitory processor executable instructions included in the memory that when executed by the processor cause the processor to carry out the method for image based customization comprising:
a) extracting one or more feature parameters of a subject in a digital image with one or more neural networks trained with a machine learning algorithm configured to determine feature parameters of the subject;
b) applying the one or more feature parameters to a virtual model of the subject.

24. A computer-readable medium having non-transitory instruction included therein wherein the non-transitory instructions are configured to cause a computer to carry out a method for image based customization when executed by a computer, the method comprising:
a) extracting one or more feature parameters of a subject in a digital image with one or more neural networks trained with a machine learning algorithm configured to determine feature parameters of the subject;
b) applying the feature parameters to a virtual model of the subject.
